(19) United States
(12) Patent Application Publication
(10) Pub. No.: US 2014/0352687 A1
(43) Pub. Date: Dec. 4, 2014

(54) HYPER CONCENTRATOR FOR MAPLE SAP

(71) Applicant: MEMPROTEC INC., Chesterville (CA)

(72) Inventor: Denis CÔTÉ, Chesterville (CA)

(73) Assignee: MEMPROTEC INC., Chesterville (CA)

(21) Appl. No.: 14/291,370

(22) Filed: May 30, 2014

(30) Foreign Application Priority Data
May 31, 2013 (GB) 1309813.2

(51) Int. Cl. C13K 13/00

(52) U.S. Cl. CPC C13K 13/007
USPC 127/9; 127/53

(57) ABSTRACT

The present disclosure relates to hyper concentrator system having two concentration modules. A first concentration module operates at a first pressure. It receives a liquid having a first Brix level and produces a first concentrate having an intermediate Brix level greater than the first Brix level. A second concentration module operates at a second pressure greater than the first pressure. The second concentration module receives the first concentrate and produces a second concentrate having a high Brix level greater than the intermediate Brix level. The hyper concentrator system may further comprise an evaporator. The hyper concentrator system may be used to produce maple syrup from maple sap.

### TECHNICAL FIELD

The present disclosure relates to the field of maple syrup production. More specifically, the present disclosure relates to a hyper concentrator system for maple sap.

### BACKGROUND

Producing maple syrup involves boiling huge quantities of maple sap. This, of course requires a lot of heat.

Nanofiltration has been used for some times to increase the percentage of sugar (Brix) of maple sap prior to its boiling. An example of a system using nanofiltration to produce maple syrup from maple sap is described in Patent Application Publication US 2011/0220564A1, “Reverse Osmosis for Maple Sap” to Denis Côté, Sep. 15, 2011, the disclosure of which is incorporated by reference in its entirety. As another example, FIG. 1 is a schematic diagram of a conventional maple sap concentrator using a nanofiltration system. Natural sap from a 2° Brix tank 142 is fed by a valve V9 to a nanofiltration system 20. A strainer 75 removes large particles that may be present in the sap and a bank of filters 16a, for example 5 micron filters, removes smaller particles. The nanofiltration system 20 separates the sap into two liquids by means of a pressure pump (not shown), recirculation pumps 24 and filtering modules 25. A concentrate 201 is fed to an open concentrate tank 144. A permeate 202 is fed to a permeate tank 146. The permeate 202 may be fed via valves V10 and V11 to a drain. The concentrate 201 is then brought into an evaporator 402 having a ridged pan 404 and compartments 403. The ridged pan 404 allows the evaporator 402 to provide sufficient heat transfer to the concentrate 201 to increase its Brix level to that of a syrup.

Though the nanofiltration system 20 increases the Brix level of the maple sap, there is still a large amount of water in the concentrate 201. Large amounts of energy are still required to obtain a final product in the evaporator 402. In most cases, heat is obtained by burning wood, oil or similar combustible material, which creates significant pollution.

With the increased awareness of the cost of energy and pollution, there is a need for a more efficient way of obtaining maple syrup.

### SUMMARY

According to the present disclosure, there is provided a hyper concentrator system having two concentration modules. A first concentration module operates at a first pressure. It receives a liquid having a first Brix level and produces a first concentrate having an intermediate Brix level greater than the first Brix level. A second concentration module operates at a second pressure greater than the first pressure. The second concentration module receives the first concentrate and produces a second concentrate having a high Brix level greater than the intermediate Brix level.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIGS. 1a, 1b and 1c (collectively FIG. 1) is a schematic diagram of a conventional maple sap concentrator using a nanofiltration system;

FIGS. 2a, 2b, 2c and 2d (collectively FIG. 2) is a schematic diagram of a hyper concentrator system for maple sap according to a first embodiment;

FIGS. 3a, 3b, 3c and 3d (collectively FIG. 3) is a schematic diagram of the hyper concentrator system for maple sap of FIG. 2 detailing operation of two concentration modules;

FIGS. 4a, 4b, 4c and 4d (collectively FIG. 4) is a schematic diagram of a hyper concentrator system for maple sap according to a second embodiment; and

FIGS. 5a, 5b, 5c and 5d (collectively FIG. 5) is a schematic diagram of the hyper concentrator system for maple sap of FIG. 4 detailing operation of two concentration modules.

Like numerals represent like features on the various drawings. Connectors a to z as well as α, β, γ and δ express how elements of the various drawings interconnect and do not represent any functional element.

### DETAILED DESCRIPTION

Various aspects of the present disclosure generally address one or more of the problems related to energy cost and pollution related to the production of maple syrup.

The disclosed hyper concentrator system uses two concentration modules, or stages to concentrate maple sap to a high Brix level before using evaporation to produce maple syrup. Use of the hyper concentrator system is not limited to maple syrup production. The hyper concentrator system may also be used in other context such as in the production of sweet solutions from sugar cane, sweet sorghum, sugar beet, and the like. The following description makes reference to maple syrup production for ease of illustration, without limiting the present disclosure.

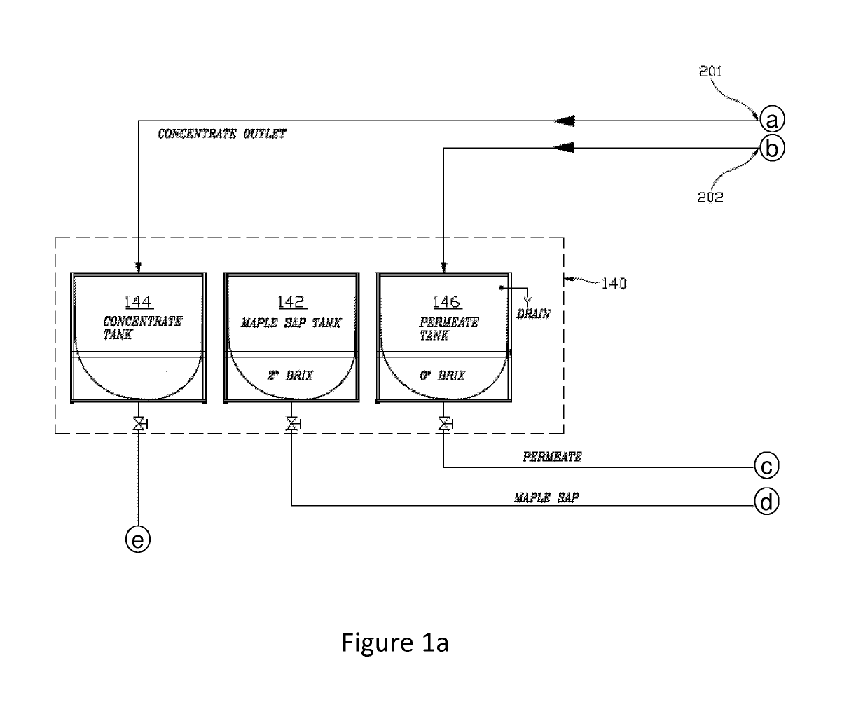

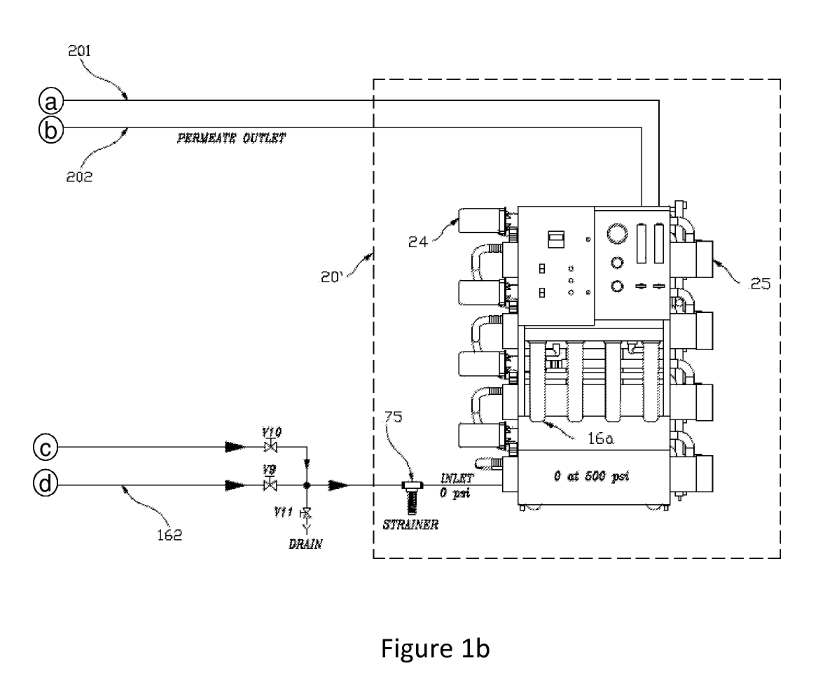

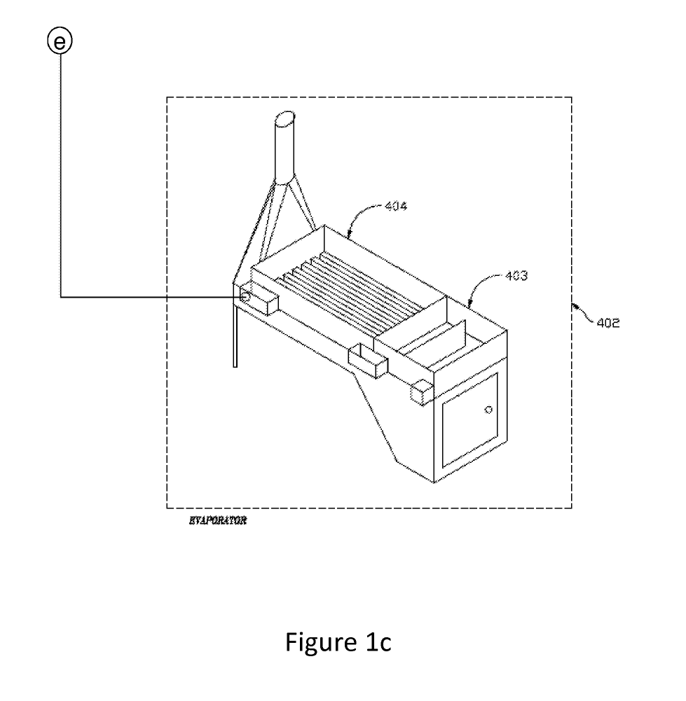

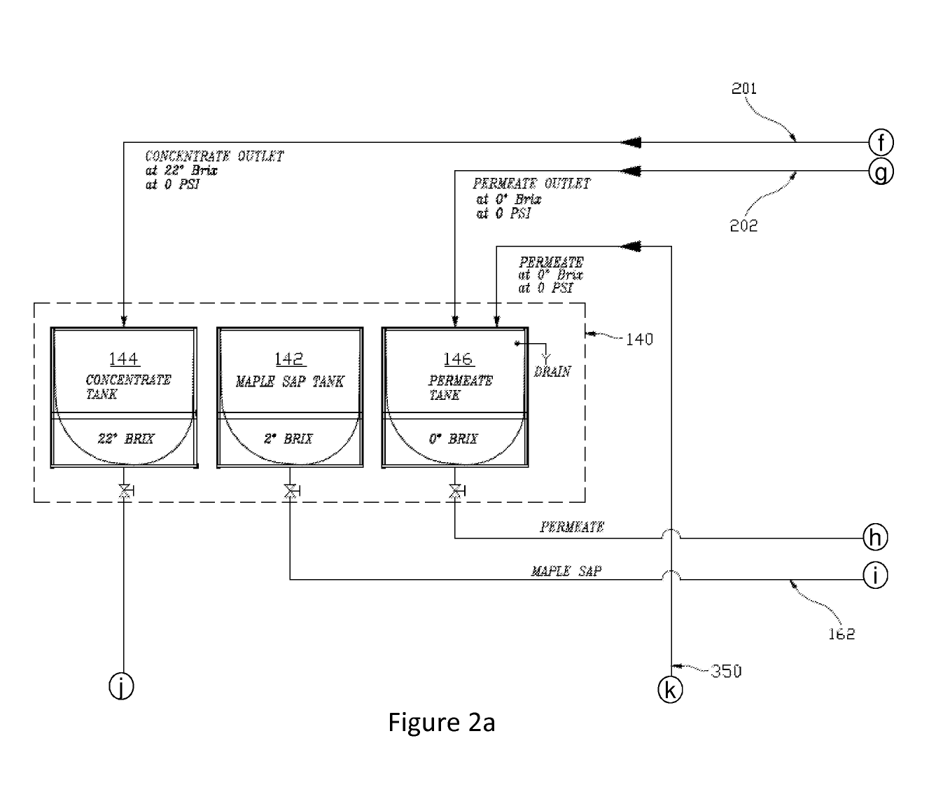

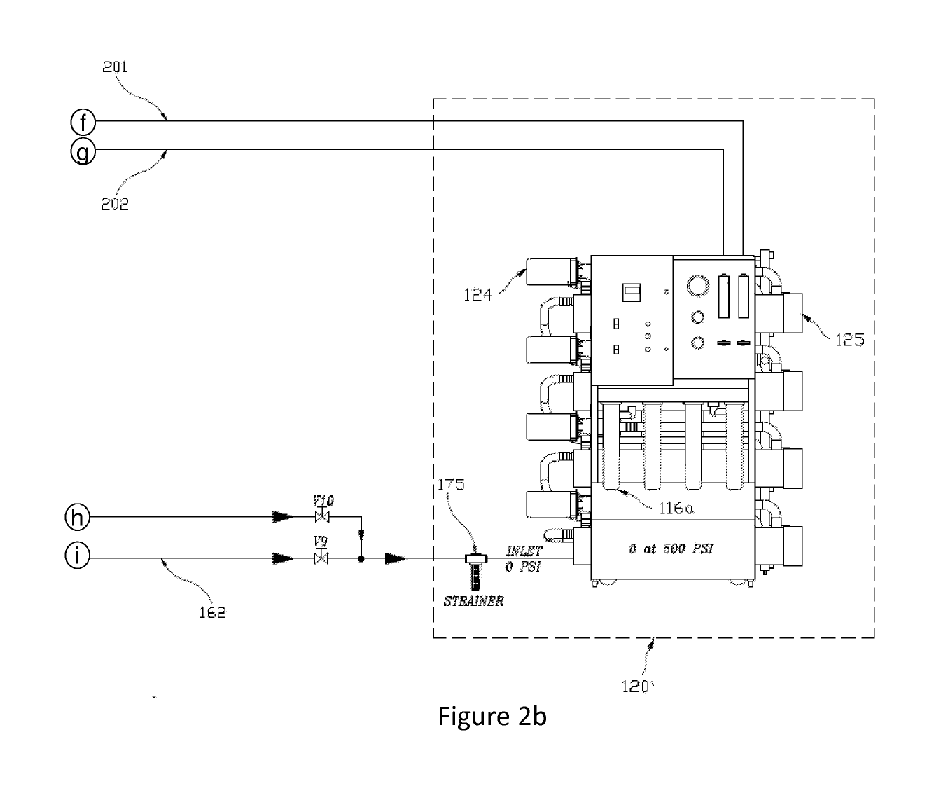

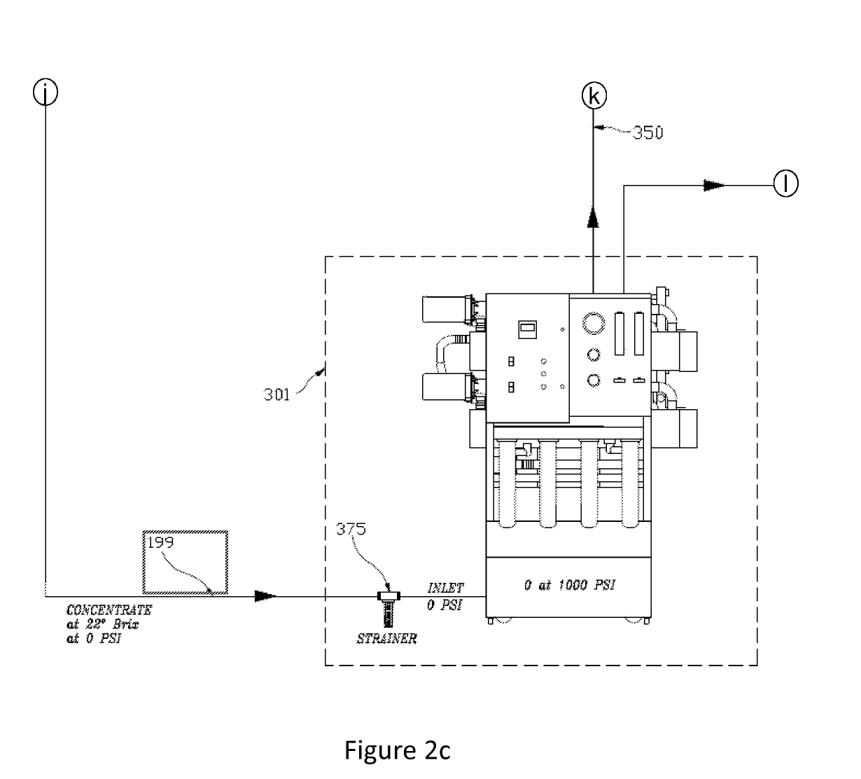

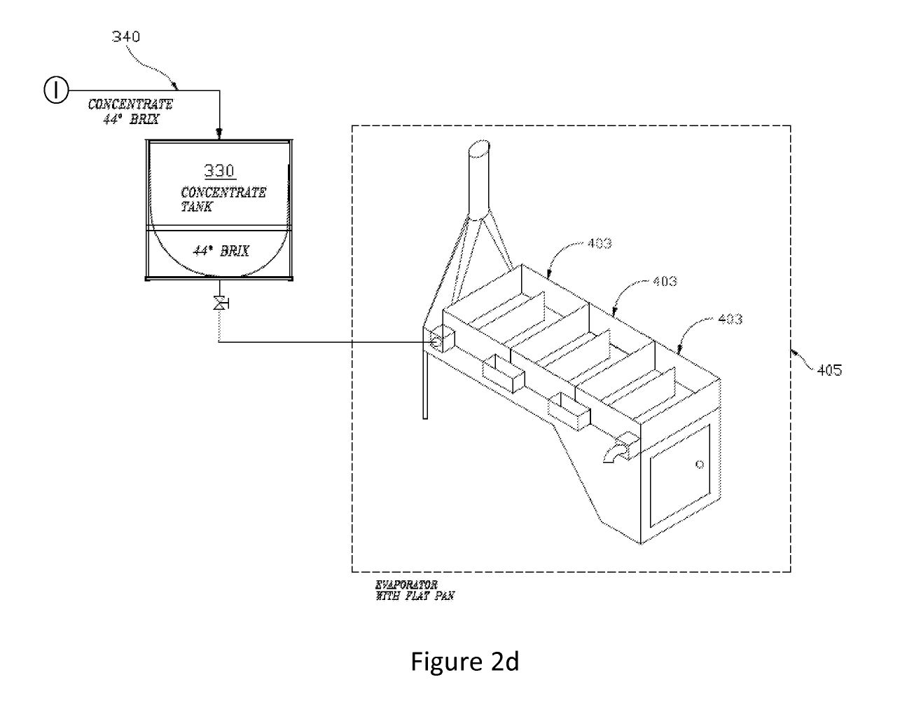

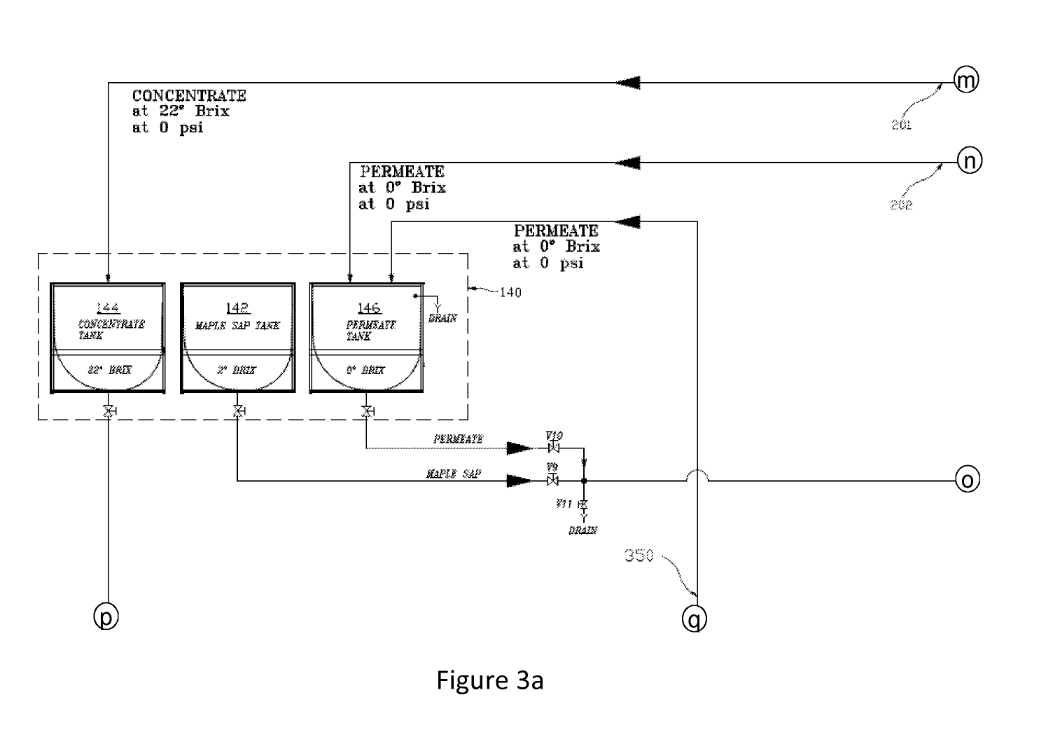

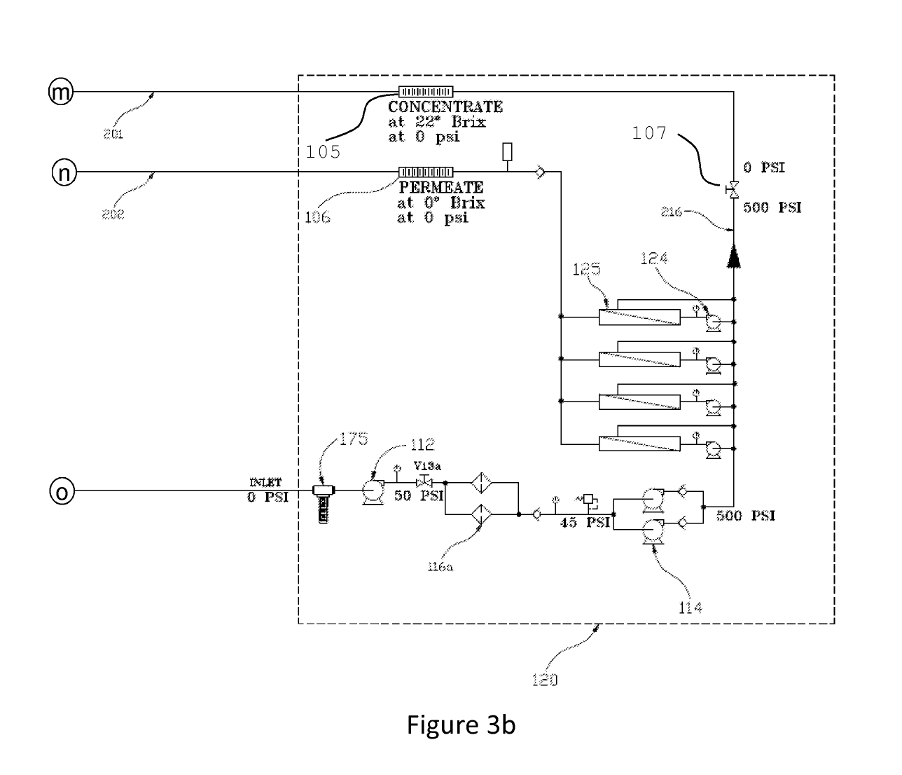

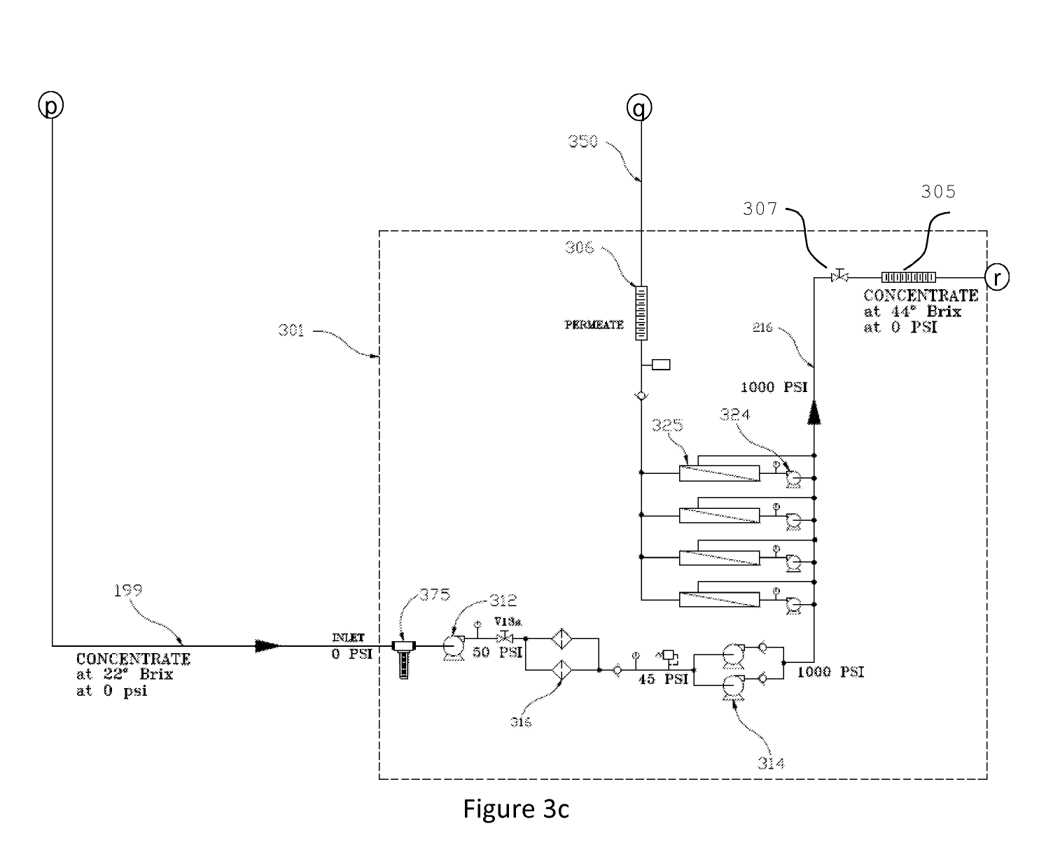

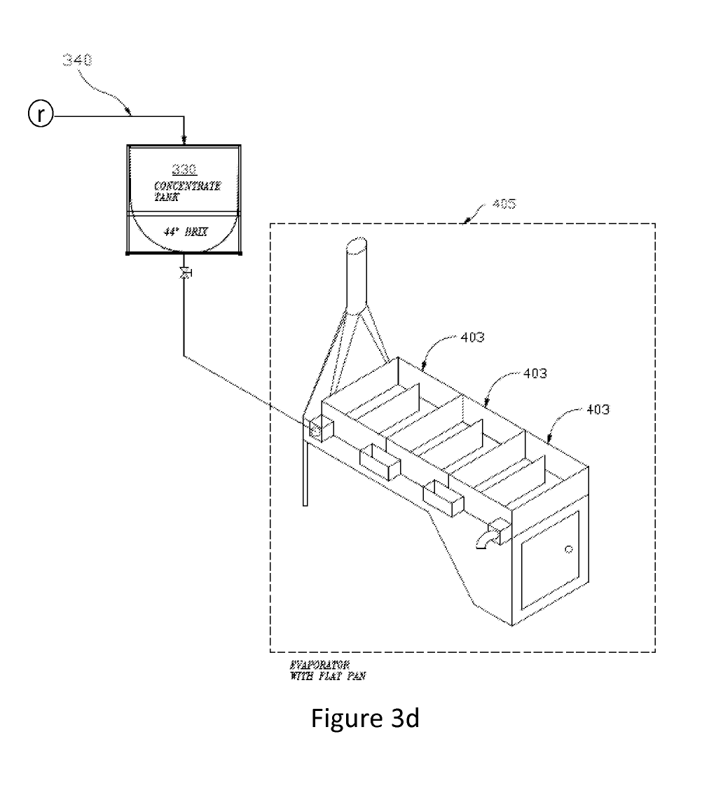

Referring now to the drawings, FIG. 2 is a schematic diagram of a hyper concentrator system for maple sap according to a first embodiment. FIG. 3 is a schematic diagram of the hyper concentrator system for maple sap of FIG. 2 detailing operation of two concentration modules. Referring at once to FIGS. 2 and 3, the hyper concentrator system for maple sap includes two concentration modules 120 and 301. The hyper concentrator system for maple sap increases the Brix level of the maple sap in two operations before feeding a hyper concentrate to an evaporator 405. As discussed hereinbelow, the evaporator 405 may differ from the ridged pan evaporator 402 of FIG. 1.

The first concentration module 120 includes a strainer 175, a feed pump 112, a bank of filters 116a, for example 5-micron filters, one more pressure pumps 114, one or more recirculation pumps 124, one or more filtering modules 125, two flow meters 105 and 106 and a throttling device, for example a throttle valve 107. In one aspect, the pressure pumps 114, the recirculation pumps 124 and the filtering modules 125 may be similar to the pressure pump, recirculation pumps and filtering modules of FIG. 1, in which case the first concentration module 120 is a nanofiltration system. In another aspect, the pressure pumps 114, the recirculation pumps 124 and the filtering modules 125 may operate at a high pressure in a 350-550 psi range, for example 500 psi, in which case the first concentration module 120 may either be viewed as a nanofiltration system or as a reverse osmosis filter.

The second concentration module 301 may also be a reverse osmosis filter. It includes a strainer 375, a feed pump 312, for example a positive displacement pump such as a piston pump, a bank of filters 316, for example 5-micron filters, one more pressure pumps 314, which may for example comprise centrifugal pumps, one or more recirculation pumps 324, one or more filtering modules 325, two flow meters 305 and 306 and a throttle valve 307 or any other throttling device.

In the embodiment of FIGS. 2 and 3, the first concentration module 120 takes the sap from a 2° Brix tank 142. The strainer 175 removes large particles that may be present in the sap and the bank of filters 116a removes smaller particles. The first concentration module 120 separates the sap into two liquids by means of its feed pump 112, pressure pumps 114, recirculation pumps 124 and filtering modules 125. One such liquid is a first concentrate 201 in a 15 to 25° Brix range, for example about 22° Brix. The throttle valve 107 reduces a pressure of the first concentrate 201 from an operating pressure of the first concentration module 120, for example 500 psi, to 0 psi above atmospheric pressure before feeding the first concentrate 201 to an open concentrate tank 144. The other liquid is a permeate 202 at about 0° Brix. A pressure of the permeate 202 is brought down to 0 psi by the filtering modules 125 before being fed to the permeate tank 146.

Rather than being immediately fed to an evaporator, the concentrate 201 is fed to the second concentration module 301. The reverse osmosis system 301 may operate at a high pressure sufficient to compensate for the osmotic pressure, for example about 1000 psi or up to 1200 psi or more. The pressure pumps 314, the recirculation pumps 324 and the filtering modules 325 are rated to withstand this operating pressure. The high operating pressure of the second concentration module 301 allows reversal of the natural osmosis of the about 22° Brix concentrate 201 to provide a hyper concentrate 216 in a 35 to 45° Brix range, for example about 44° Brix. Conventional nanofiltration and reverse osmosis system used to produce maple syrup or similar products operate at much lower pressure levels and produce concentrates at much lower Brix levels.

A pressure of the about 44° Brix hyper concentrate 216 is reduced to 0 psi by the throttle valve 307. The 44° Brix hyper concentrate 216 is then fed to an additional concentrate tank 330 and further to an evaporator 405 in which maple syrup at about 67° Brix is produced. Because it receives a highly concentrated maple sap, the evaporator 405 may be simpler, less bulky and more economical than the bulky, ridged pan evaporator 402 of FIG. 1. It may for example have a flat pan instead of a ridged pan. A flat pan evaporator 405 reduces risks of degradation due to excessive heat transfer to the hyper concentrate 216.

A pressure of a second 0° Brix permeate 350 is also reduced to 0 psi by the filtering modules 325. The permeate 350 is then fed to the permeate tank 146, from which the permeate 350 may be disposed.

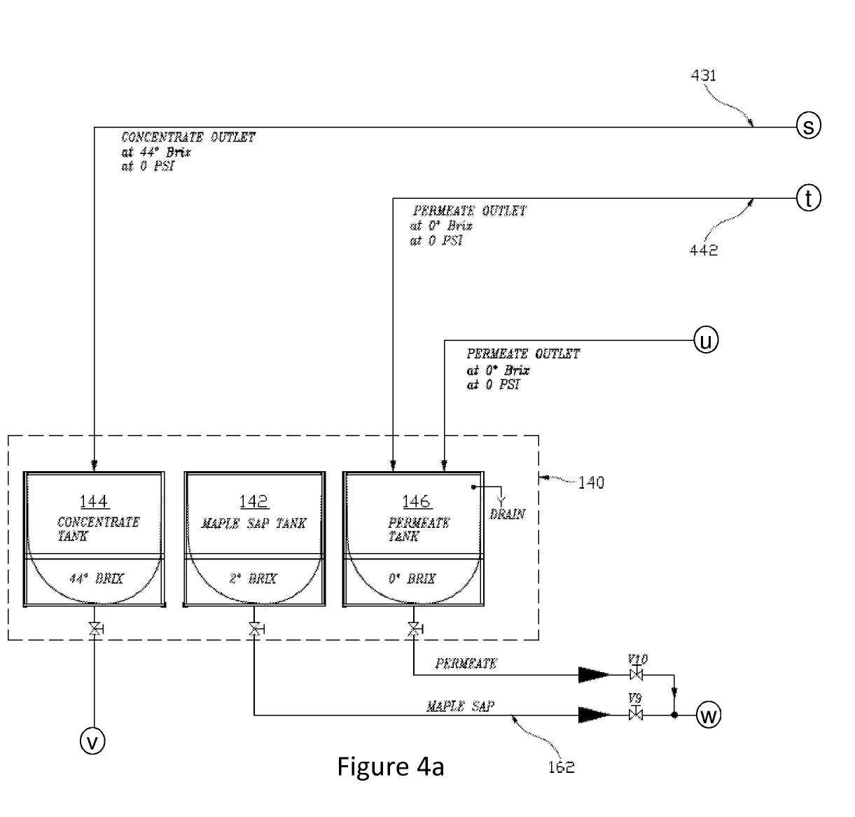

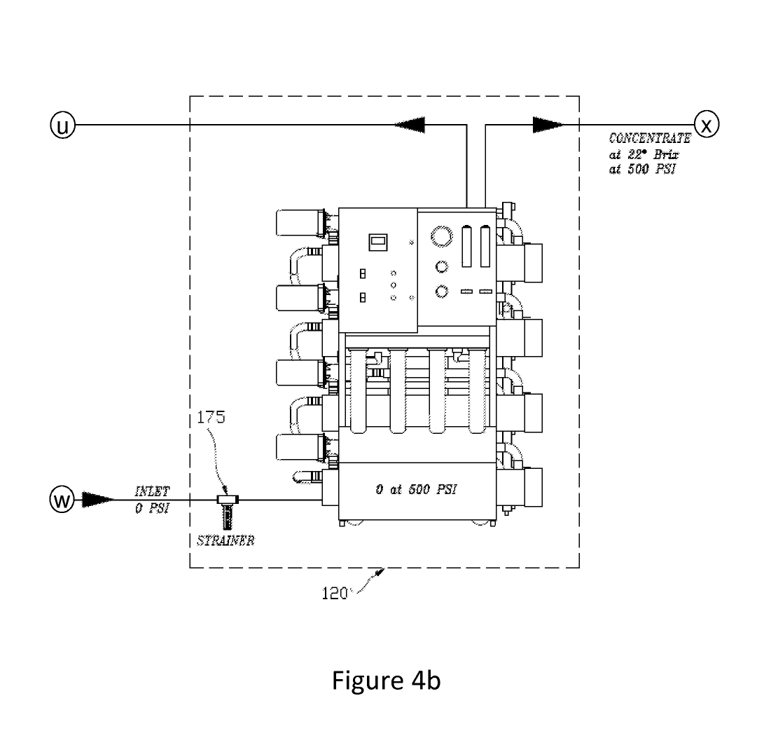

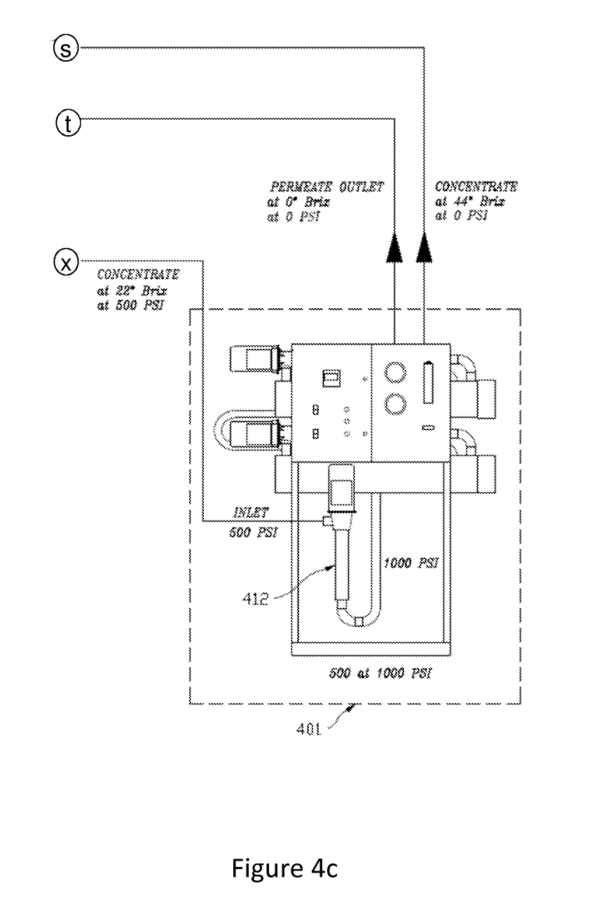

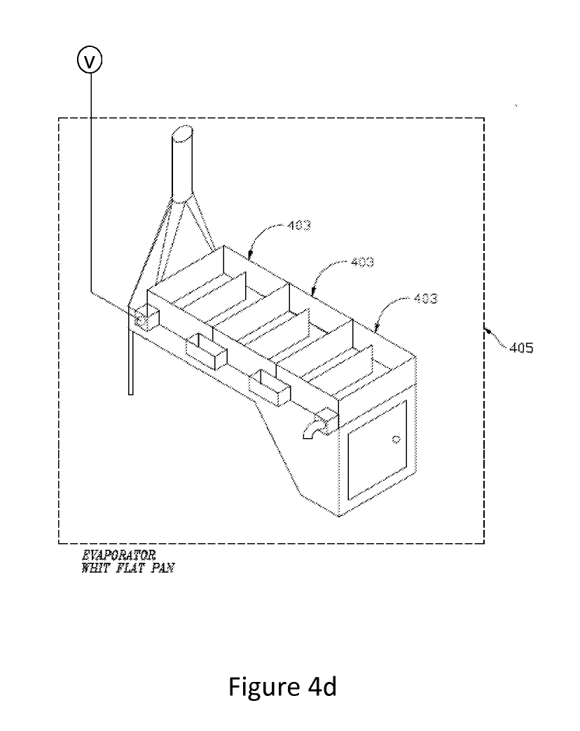

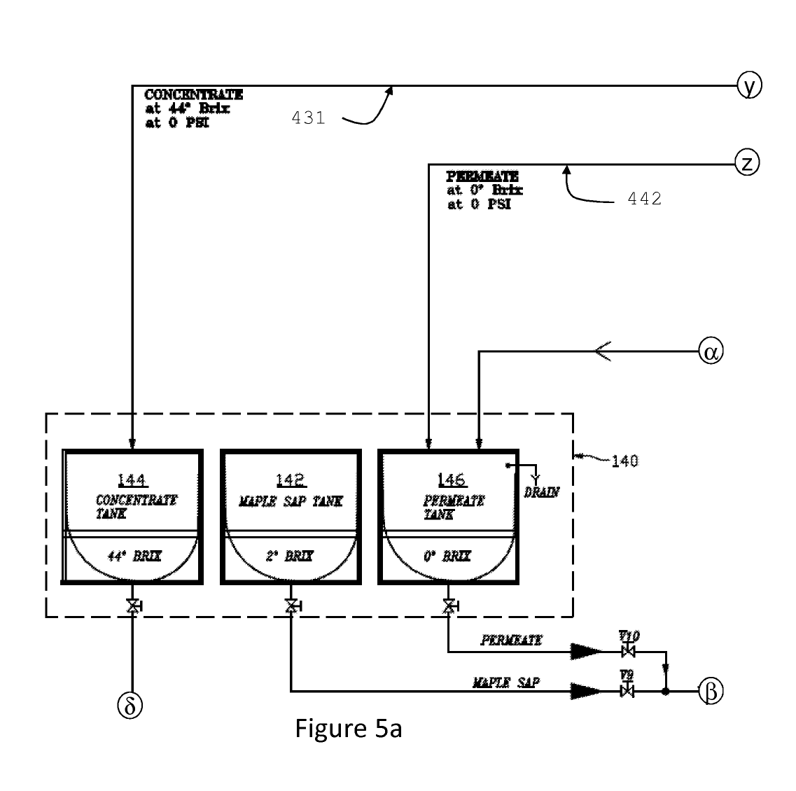

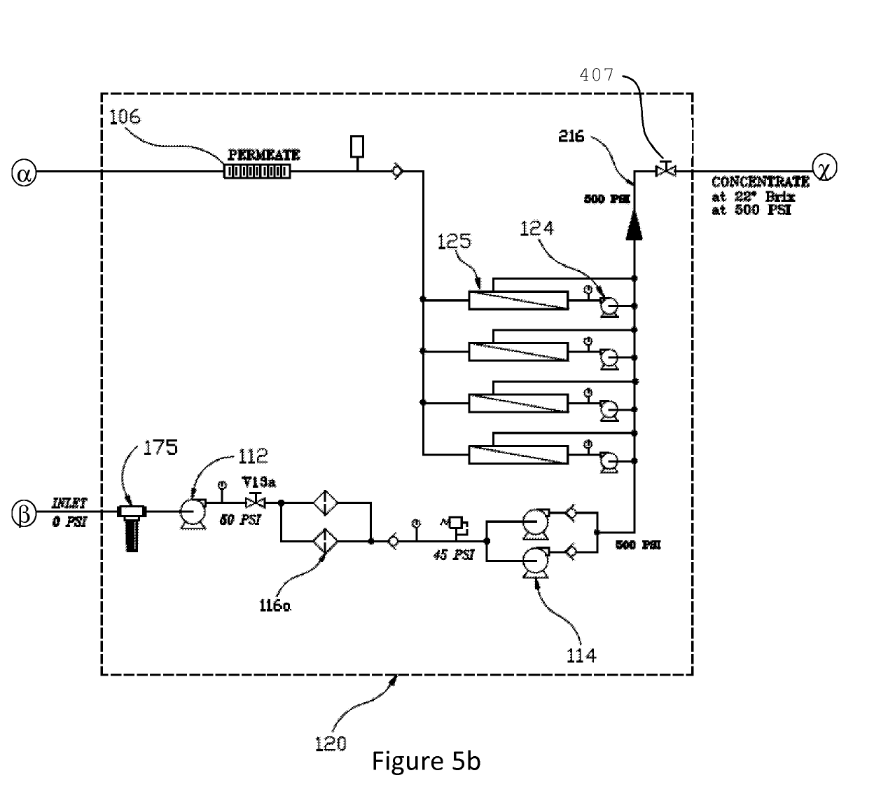

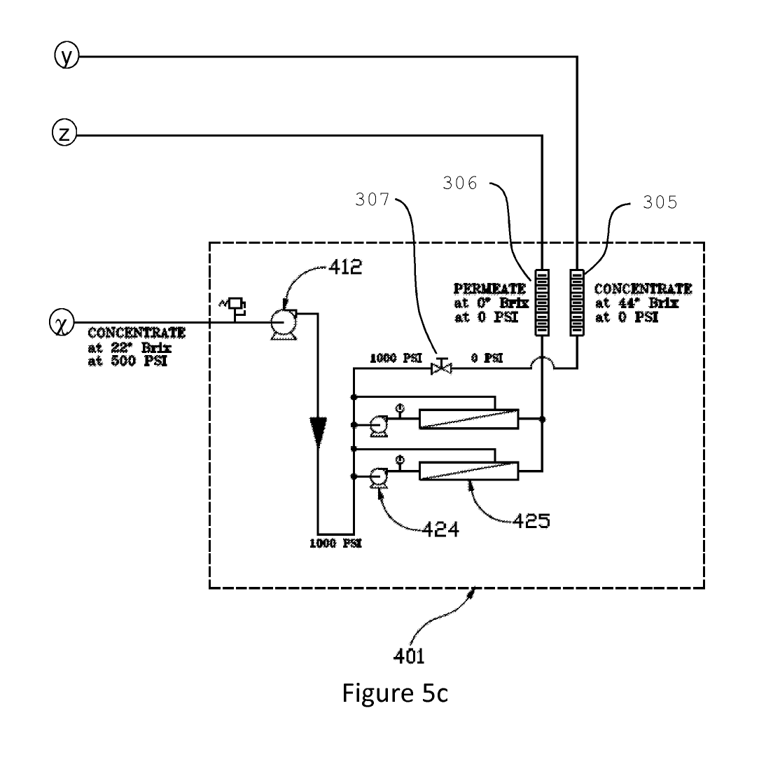

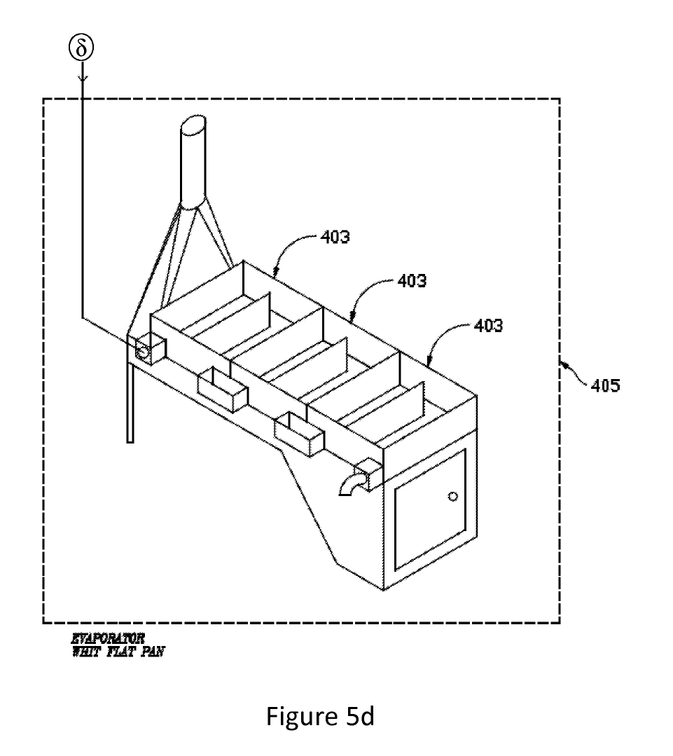

FIG. 4 is a schematic diagram of a hyper concentrator system for maple sap according to a second embodiment. FIG. 5 is a schematic diagram of the hyper concentrator system for maple sap of FIG. 4 detailing operation of two concentration modules. Comparing the second embodiment to the first embodiment of FIGS. 2 and 3, a first 22° Brix concentrate 216 produced by the first concentration module 120 is directly fed to a second concentration module 401 via a low restriction valve 407, substantially without reducing its 350-550 psi pressure and without transiting to a concentrate tank. The second concentration module 401 includes one or more pressure pumps 412, which may for example comprise centrifugal pumps, one or more recirculating pumps 424 and modules 425, but does not need to include a strainer, a feed pump or a 5 micron filter. The second concentration module 401 increases the Brix level of the first 22° Brix concentrate 216 to about 35 to 45° Brix, for example 44° Brix, at 1000 PSI or more. The throttle valve 407 reduces the pressure of a resulting 44° Brix hyper concentrate 431 to 0 PSI. The concentrate tank 144 receives the 44° Brix hyper concentrate 431 while the permeate tank 146 still receives a 0° Brix permeate 442 at 0 PSI. The 44° Brix hyper concentrate 431 is directly fed from the concentrate tank 144 to the flat pan evaporator 405.

It will be observed that the second embodiment of FIGS. 4 and 5 comprises fewer components when compared to the first embodiment of FIGS. 2 and 3, including one less concentrate tank, one less flow meter and a simpler second concentration module 401, one simpler valve 407 replacing the throttle valve 107. Reduced loss of energy is obtained by not having to lower the pressure of the first 22° Brix concentrate 216. While saving energy, this also has the effect of reducing bacteria growth, producing better tasting maple syrup.

It will also be observed that the conventional maple sap concentrator of FIG. 1 may easily be converted to the disclosed hyper concentrator system for maple sap by addition of a few components, including the additional second concentration module 301 or 401.

Variants of either embodiments of the hyper concentrator system may produce syrup without using any evaporator. However, use of the evaporator 405 is instrumental in giving the maple syrup its particular taste.

Those of ordinary skill in the art will realize that the description of the hyper concentrator system for maple sap are illustrative only and are not intended to be in any way limiting. Other embodiments will readily suggest themselves to such persons with ordinary skill in the art having the benefit of the present disclosure. Furthermore, the disclosed hyper concentrator system for maple sap may be customized to offer valuable solutions to existing needs and problems of energy cost and pollution related to the production of maple syrup.

In the interest of clarity, not all of the routine features of the implementations of hyper concentrator system for maple sap are shown and described. It will, of course, be appreciated that in the development of any such actual implementation of the hyper concentrator system for maple sap, numerous implementation-specific decisions may need to be made in order to achieve the developer's specific goals, such as compliance with application-related and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of maple syrup production having the benefit of the present disclosure.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A hyper concentrator system, comprising:
a first concentration module operating at a first pressure to receive a liquid having a first Brix level and to produce a first concentrate having an intermediate Brix level greater than the first Brix level; and
a second concentration module operating at a second pressure greater than the first pressure, the second concentration module being configured to receive the first concentrate and to produce a second concentrate having a high Brix level greater than the intermediate Brix level.

2. The hyper concentrator system of claim 1, wherein:
the first concentration module is selected from a first nanofiltration system and a first reverse osmosis filter; and
the second concentration module is selected from a second nanofiltration system and a second reverse osmosis filter.

3. The hyper concentrator system of claim 1, comprising an evaporator configured to receive the second concentrate and to increase further the Brix level to produce a syrup.

4. The hyper concentrator system of claim 3, wherein the evaporator is configured to produce the syrup at about 67° Brix.

5. The hyper concentrator system of claim 3, wherein the evaporator is a flat pan evaporator.

6. The hyper concentrator system of claim 1, comprising:
a first concentrate tank connected to the first concentration module to receive therefrom the first concentrate, the second concentration module being configured to receive the first concentrate from the first concentrate tank; and
a second concentrate tank connected to the second concentration module to receive therefrom the second concentrate.

7. The hyper concentrator system of claim 6, comprising an evaporator configured to receive the second concentrate from the second concentrate tank.

8. The hyper concentrator system of claim 6, comprising:
a first throttling device to reduce a pressure of the first concentrate entering the first concentrate tank; and
a second throttling device to reduce a pressure of the second concentrate entering the second concentrate tank.

9. The hyper concentrator system of claim 1, comprising:
a concentrate tank connected to the second concentration module to receive therefrom the second concentrate;
wherein the second concentration module is configured to receive the first concentrate from the first concentration module.

10. The hyper concentrator system of claim 9, wherein a low restriction between the first and second concentration modules allows the first concentrate to enter the second concentration module substantially at the first pressure.

11. The hyper concentrator system of claim 9, comprising an evaporator configured to receive the second concentrate from the concentrate tank.

12. The hyper concentrator system of claim 9, comprising:
a throttling device to reduce a pressure of the second concentrate entering the concentrate tank.

13. The hyper concentrator system of claim 1, wherein the first pressure is at least 350 psi.

14. The hyper concentrator system of claim 13, wherein the second pressure is at least 1000 psi.

15. The hyper concentrator system of claim 1, wherein the Brix level of the first concentrate is in a 15 to 25° Brix range.

16. The hyper concentrator system of claim 1, wherein the Brix level of the second concentrate is in a 35 to 45° Brix range.

17. The hyper concentrator system of claim 1, wherein each of the first and second concentration modules comprise:
one or more pressure pumps;
one or more recirculation pumps; and
one or more filtering modules.

18. The hyper concentrator system of claim 17, wherein a flow of a liquid entering each of the first and second concentration modules passes through the one or more pressure pumps before being split in a plurality of paths, each path including one recirculation pump and one filtering module.

19. The hyper concentrator system of claim 17, wherein each filtering module is configured to separate a liquid having a given Brix level into a concentrate having a Brix level greater than the given Brix level and a permeate having a Brix level lower than the given Brix level.

20. The hyper concentrator system of claim 17, wherein the first concentration module further comprises:
a first strainer;
a first feed pump; and
a first bank of filters;
wherein the first strainer, the first feed pump and the first bank of filters are upstream of the one more pressure pumps, of the one or more recirculation pumps and of the one or more filtering modules of the first concentration module.

21. The hyper concentrator system of claim 20, wherein the second concentration module further comprises:
a second strainer;
a second feed pump; and
a second bank of filters.

22. Use of the hyper concentrator system of claim 1 for conversion of maple sap into maple syrup.
